(19) United States
(12) Patent Application Publication
(10) Pub. No.: US 2022/0261440 A1
(43) Pub. Date: Aug. 18, 2022

(54) GRAPH ANALYSIS DEVICE, GRAPH ANALYSIS METHOD, AND GRAPH ANALYSIS PROGRAM

(71) Applicant: NIPPON TELEGRAPH AND TELEPHONE CORPORATION, Tokyo (JP)

(72) Inventors: Satoshi FURUTANI, Musashino-shi, Tokyo (JP); Toshiki SHIBAHARA, Musashino-shi, Tokyo (JP); Mitsuaki AKIYAMA, Musashino-shi, Tokyo (JP); Kunio HATO, Musashino-shi, Tokyo (JP)

(73) Assignee: NIPPON TELEGRAPH AND TELEPHONE CORPORATION, Tokyo (JP)

(21) Appl. No.: 17/623,622

(22) PCT Filed: Jul. 11, 2019
(86) PCT No.: PCT/JP2019/027618

§ 371 Date: Dec. 29, 2021

(51) Int. Cl. G06F 16/901; G06F 17/16

(52) U.S. Cl. CPC G06F 16/9024; G06F 17/16

(57) ABSTRACT

A conversion unit converts directions of edges between vertices in a graph to arguments on a complex plane. A generation unit generates a Hermitian matrix that represents a relationship between vertices in the graph by using the arguments converted by the conversion unit. A calculation unit calculates eigenvectors of the Hermitian matrix generated by the generation unit. A signal processing unit performs graph signal processing such as graph Fourier transform taking the eigenvectors calculated by the calculation unit to be a Fourier basis for a graph Laplacian.

### TECHNICAL FIELD

The present invention relates to a graph analysis device, a graph analysis method, and a graph analysis program.

### BACKGROUND ART

Graph signal processing in which traditional signal processing is generalized for signals on a graph is known. Here, traditional signal processing refers to theories or technologies that realize efficient transmission, compression, storage, analysis, etc., of signals by converting signals such as images or audio that are arranged on an ordered lattice-shaped structure to a frequency domain through spatio-temporal frequency analysis.

The graph signal processing is a fundamental theory in many graph analysis technologies, and is applied to technologies in which technologies of the traditional signal processing such as signal noise removal are extended as they are for graph signals, as well as various graph analysis technologies such as community extraction and representation learning of graphs and establishment of convolutional neural networks for graph data.

When establishing a theory of the graph signal processing, a concept that serves as a basis is graph Fourier transform. A basic method for defining the graph Fourier transform is a method that is based on eigenvectors of a graph Laplacian (see NPL 1, for example). Here, the graph Laplacian is a matrix that describes a diffusion phenomenon on a graph.

### CITATION LIST

### Non Patent Literature

[NPL 1] Shuman, D. I., Narang, S. K., Frossard, P., Ortega, A., Vandergheynst, P.: The emerging field of signal processing on graphs: Extending high-dimensional data analysis to networks and other irregular domains. IEEE Signal Processing Magazine 30(3), 83-98 (2013)

### SUMMARY OF THE INVENTION

### Technical Problem

However, conventional graph signal processing has a problem in that there are cases where the graph signal processing cannot be applied to directed graphs. In the graph signal processing, a Fourier basis is established as eigenvectors of the graph Laplacian. The graph Laplacian of an undirected graph is a real symmetric matrix, and therefore eigenvectors can be always selected so as to be orthogonal. Orthogonality of the eigenvectors is essential for the graph Fourier transform to have mathematically desirable characteristics.

On the other hand, many pieces of graph data existing in the real world are directed graphs, i.e., graphs in which edges have directions, and accordingly, extending the graph signal processing to directed graphs is an important issue. However, a graph Laplacian that represents a directed graph is an asymmetric matrix, and therefore, eigenvectors of the graph Laplacian are commonly not orthogonal. Accordingly, even if a Fourier basis is established using eigenvectors of the graph Laplacian representing the directed graph, the graph Fourier transform does not have mathematically desirable characteristics. That is, the graph signal processing and various graph analysis technologies to which the graph signal processing is applied cannot be applied to directed graphs.

### Means for Solving the Problem

In order to solve the problems described above and achieve an object, a graph analysis device includes: a conversion unit configured to convert directions of edges between vertices in a graph to arguments on a complex plane; a generation unit configured to generate a Hermitian matrix that represents a relationship between vertices in the graph using the arguments converted by the conversion unit; and a calculation unit configured to calculate eigenvectors of the Hermitian matrix generated by the generation unit.

### Effects of the Invention

According to the present invention, it is possible to apply graph signal processing to directed graphs.

### BRIEF DESCRIPTION OF DRAWINGS

FIG. 1 is a diagram showing an example configuration of a graph analysis device according to a first embodiment.

FIG. 2 is a diagram showing an example representation of an undirected graph.

FIG. 3 is a diagram showing an example representation of a directed graph.

FIG. 4 is a diagram showing a method for converting edges.

FIG. 5 is a diagram showing the method for converting edges.

FIG. 6 is a diagram showing the method for converting edges.

FIG. 7 is a diagram showing a graph Laplacian.

FIG. 8 is a diagram showing a method for generating a matrix.

FIG. 9 is a diagram showing extension of graph analysis technologies.

FIG. 10 is a flowchart showing a flow of processing performed by the graph analysis device according to the first embodiment.

FIG. 11 is a diagram showing a graph according to an example.

FIG. 12 is a diagram showing a method for calculating a graph wavelet.

FIG. 13 is a diagram showing embedded representations of vertices in the graph.

FIG. 14 is a diagram showing an example of a computer that executes a graph analysis program.

### DESCRIPTION OF EMBODIMENTS

The following describes an embodiment of a graph analysis device, a graph analysis method, and a graph analysis program according to the present application in detail based on the drawings. Note that the present invention is not limited by the embodiment described below.

### Configuration of First Embodiment

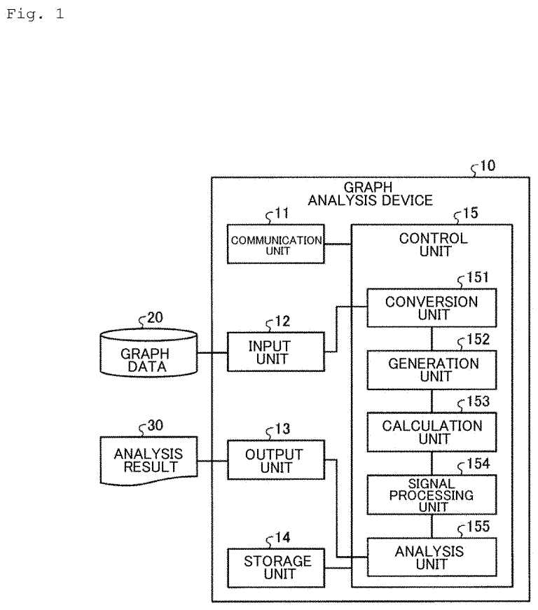

First, a configuration of a graph analysis device according to a first embodiment will be described using FIG. 1. FIG. 1 is a diagram showing an example of the configuration of the graph analysis device according to the first embodiment. As shown in FIG. 1, a graph analysis device 10 accepts input of graph data 20, performs analysis regarding a graph, and outputs an analysis result 30.

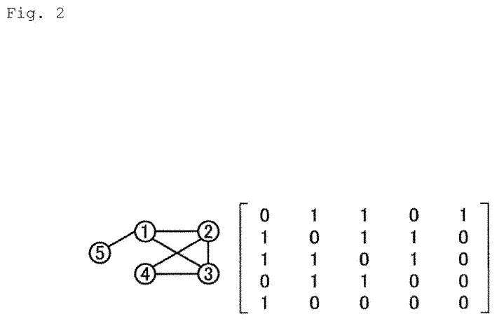

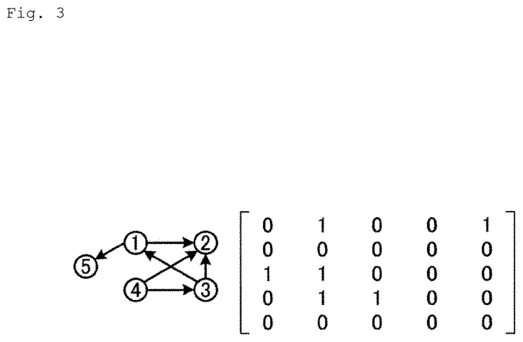

The graph data 20 is data that represents the graph using a predetermined method. In the present embodiment, the graph data 20 is represented by an adjacency matrix. For example, an undirected graph is represented by an adjacency matrix such as that shown in FIG. 2. FIG. 2 is a diagram showing an example representation of an undirected graph. Also, a directed graph is represented by an adjacency matrix such as that shown in FIG. 3. FIG. 3 is a diagram showing an example representation of a directed graph.

Here, the adjacency matrix that represents the graph data 20 is defined as follows. First, if an edge does not exist between vertices in the graph, an element that corresponds to the edge in the adjacency matrix is 0. Next, if there is an undirected edge between vertices in the graph, an element that corresponds to the edge in the adjacency matrix is 1. Also, if there is a directed edge that is directed from a vertex i to a vertex j in the graph, an element (i,j) in the adjacency matrix is 1 and an element (j,i) in the adjacency matrix is 0.

For example, in the undirected graph shown in FIG. 2, there is an undirected edge between vertices 1 and 2. Therefore, the (1,2) element and the (2,1) element in the adjacency matrix shown in FIG. 2 are 1. That is, in the adjacency matrix of the undirected graph, the (i,j) element and the (j,i) element are the same value. As described above, the adjacency matrix representing the undirected graph is a symmetrical matrix.

Also, in the directed graph shown in FIG. 3, a directed edge that is directed from a vertex 1 to a vertex 2 exists between the vertices 1 and 2, and therefore, the (1,2) element in the matrix is 1. On the other hand, a directed edge that is directed from the vertex 2 to the vertex 1 does not exist, and therefore, the (2,1) element is 0. Accordingly, the adjacency matrix representing the directed graph is an asymmetric matrix.

Algebraic treatment of an asymmetric matrix is usually difficult when compared to a symmetric matrix, and therefore, application of many graph analysis technologies including graph signal processing is limited to undirected graphs. Note that the graph data 20 may be any type of data so long as the graph data represents a graph. For example, the graph data 20 may be data that represents follow/follower relationships (edges) between users (vertices) of Twitter (registered trademark) using a graph or data that represents a function call relationship in a malware execution code using a graph. Also, an analysis method according to the present embodiment is obtained by extending a graph analysis method for undirected graphs to directed graphs, and accordingly, is also applicable to undirected graphs.

The graph analysis device 10 can apply analysis technologies that have been conventionally applied to undirected graphs to directed graphs. For example, in a case where the graph analysis device 10 applies a vertex classification technology to a directed graph, the analysis result 30 is a classification result of vertices. Also, in a case where the graph analysis device 10 applies a representation learning technology to a directed graph, the analysis result 30 is feature vectors.

Here, each unit of the graph analysis device 10 will be described. As shown in FIG. 1, the graph analysis device 10 includes a communication unit 11, an input unit 12, an output unit 13, a storage unit 14, and a control unit 15.

The communication unit 11 performs data communication with another device via a network. The communication unit 11 is, for example, an NIC (Network Interface Card). The input unit 12 accepts input of data from a user. The input unit 12 is, for example, an input device such as a mouse or a keyboard. The output unit 13 outputs data by displaying a screen, for example. The output unit 13 is, for example, a display device such as a display.

The storage unit 14 is a storage device such as an HDD (Hard Disk Drive), an SSD (Solid State Drive), or an optical disk. Note that the storage unit 14 may be a semiconductor memory that allows rewriting of data, such as a RAM (Random Access Memory), a flash memory, or an NVSRAM (Non Volatile Static Random Access Memory). An OS (Operating System) and various programs that are executed in the graph analysis device 10 are stored in the storage unit 14.

The control unit 15 controls the entire graph analysis device 10. The control unit 15 is, for example, an electronic circuit such as a CPU (Central Processing Unit) or an MPU (Micro Processing Unit), or an integrated circuit such as an ASIC (Application Specific Integrated Circuit) or an FPGA (Field Programmable Gate Array). The control unit 15 includes an internal memory for storing programs that define various processing procedures and control data, and executes each piece of processing using the internal memory. Also, the control unit 15 functions as various processing units as a result of various programs operating. For example, the control unit 15 includes a conversion unit 151, a generation unit 152, a calculation unit 153, a signal processing unit 154, and an analysis unit 155.

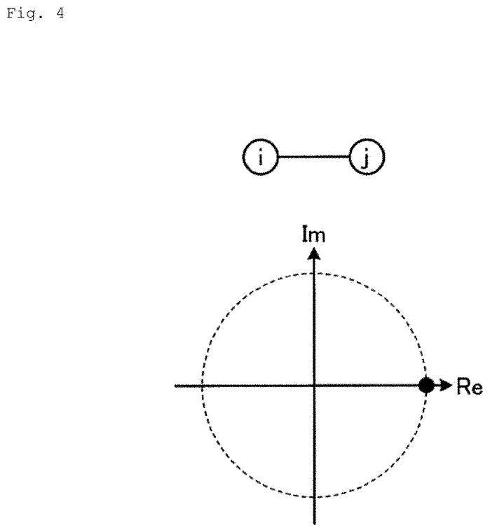

The conversion unit 151 converts directions of edges between vertices in the graph to arguments on a complex plane. For example, if the direction of an edge between vertices in the graph is a first direction, the conversion unit 151 converts the direction of the edge to a first angle, if the direction of the edge is opposite to the first direction, the conversion unit 151 converts the direction of the edge to an angle that is obtained by changing the sign of the first angle, and if the edge has no direction, the conversion unit 151 converts the direction of the edge to 0 (angle). Here, a method of the conversion performed by the conversion unit 151 will be described using FIGS. 4 to 6. FIGS. 4 to 6 are diagrams showing the method for converting edges.

First, assume that a point on the complex plane that has an absolute value of 1 and an argument of 0 is given as a reference point. As shown in FIG. 4, if there is an undirected edge between vertices i and j, i.e., if a directed edge directed from the vertex i to the vertex j and a directed edge directed from the vertex j to the vertex i coexist, the conversion unit 151 does not rotate the argument of the reference point on the complex plane. That is, the reference point represents the undirected edge or the coexisting directed edges directed in opposite directions between the vertices i and j.

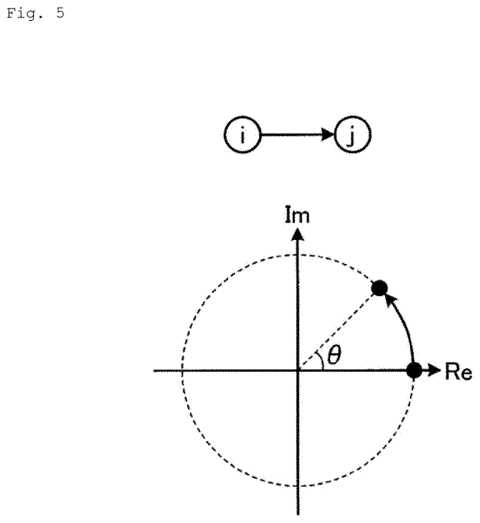

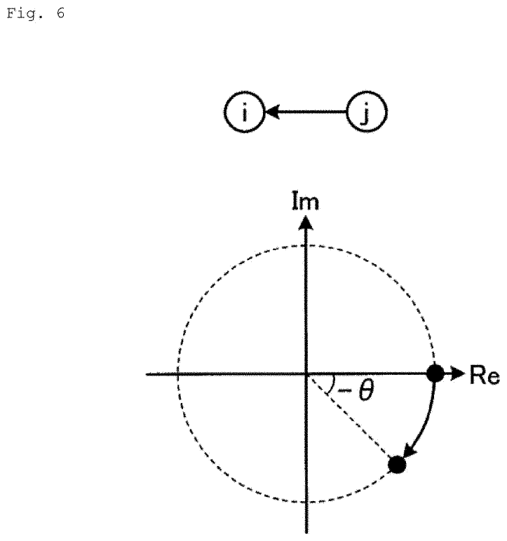

As shown in FIG. 5, if a directed edge directed from the vertex i to the vertex j exists between the vertices i and j, the conversion unit 151 rotates the argument of the reference point by θ in the positive direction on the complex plane. Conversely, as shown in FIG. 6, if a directed edge directed from the vertex j to the vertex i exists between the vertices i and j, the conversion unit 151 rotates the argument of the reference point by θ in the negative direction on the complex plane. In this case, the direction from the vertex i to the vertex j is an example of the first direction. Also, θ is an example of the first angle. θ can be set to a fixed value such as π/4, for example.

The above operations performed by the conversion unit 151 can be described as a function γ from an edge set to the first unitary group as expressed by Expression (1). In Expression (1), the oblique i represents an index of a vertex, and the upright i represents the imaginary unit.

$$\begin{matrix}[ Math . 1 ] & \\ γ ( i , j ; θ ) = {e}^{i θ ( {a}_{ij} - {a}_{j i} )} {a}_{ij} = \{ \begin{matrix}1 & i \to j \\ 0 & otherwise\end{matrix} & ( 1 )\end{matrix}$$

Note that the definition of the function γ is not limited to that expressed by Expression (1). For example, the function γ may be defined as γ=α+iβ by explicitly separating the real part and the imaginary part. Alternatively, the function γ may also be defined as a two-dimensional special orthogonal group, i.e., a 2×2 matrix expressed as γ=diag(α,β).

The generation unit 152 generates a Hermitian matrix that represents a relationship between vertices in the graph by using the arguments converted by the conversion unit 151. For example, the generation unit 152 generates a matrix that is obtained by subtracting, from a degree matrix of the graph, a matrix of which rows and columns correspond to vertices in the graph and in which, if there is an edge between vertices that correspond to an element, the element is a complex number that has an argument converted by the conversion unit 151 and a constant absolute value. In this case, elements of the matrix may be values that are obtained using the above function γ.

Here, in graph signal processing, a graph is commonly expressed using a matrix that is called a graph Laplacian. The graph Laplacian can be defined using an adjacency matrix and a degree matrix. Degrees of a graph represent the numbers of edges going out from vertices.

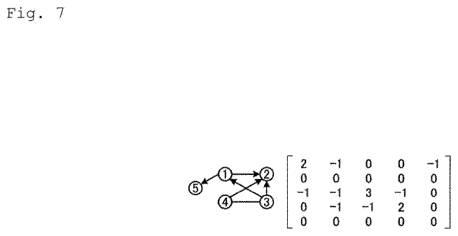

The graph Laplacian will be described using FIG. 7. FIG. 7 is a diagram showing the graph Laplacian. For example, in the graph shown in FIG. 7, two edges go out from the vertex 1 to the vertices 2 and 5, and accordingly, the degree of the vertex 1 is 2. The degree matrix is a matrix in which degrees of respective vertices are arranged as diagonal elements. When the adjacency matrix is denoted by A and the degree matrix is denoted by D, a conventional graph Laplacian Lₚᵣᵢₒᵣ can be commonly written as Lₚᵣᵢₒᵣ=D−A. As shown in FIG. 7, the adjacency matrix of a directed graph is an asymmetric matrix, and the graph Laplacian of the directed graph is also an asymmetric matrix.

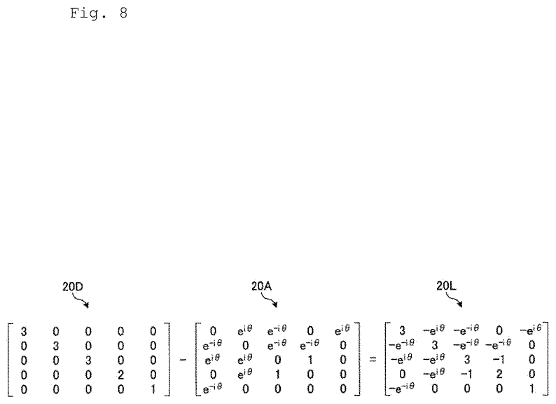

The generation unit 152 generates a matrix using a converted adjacency matrix and a degree matrix. The converted adjacency matrix is a matrix in which each element of the adjacency matrix is expressed using an argument converted by the conversion unit 151. FIG. 8 is a diagram showing a method for generating the matrix.

For example, in the directed graph that is input, a directed edge directed from the vertex 1 to the vertex 2 exists between the vertices 1 and 2 as shown in FIG. 3. Therefore, as shown in FIG. 8, in a matrix 20A that is the converted adjacency matrix, the (1,2) element is e^{iθ} and the (2,1) element is e^{-iθ}. The generation unit 152 obtains a matrix 20L by subtracting the matrix 20A from a matrix 20D that is the degree matrix.

The (1,2) element and the (2,1) element of the matrix 20L are −e^{iθ} and −e^{-iθ}, respectively. Also, there is an undirected edge between vertices 3 and 4 in the graph, and therefore, the (3,4) element and the (4,3) element of the matrix 20L are both −1. Note that the degrees shown in the matrix 20D are calculated ignoring directions of edges in the directed graph, because the directions of the edges are converted to arguments on the complex plane by the conversion unit 151.

Here, a matrix in which the (i,j) element is the complex conjugate of the (j,i) element is called a Hermitian matrix. The matrix 20L shown in FIG. 8 is apparently a Hermitian matrix. Therefore, the matrix generated by the generation unit 152 will be hereinafter referred to as a Hermitian Laplacian and will be denoted by L.

The calculation unit 153 calculates eigenvectors of the Hermitian matrix generated by the generation unit 152. Also, the signal processing unit 154 performs graph signal processing taking the eigenvectors calculated by the calculation unit 153 to be a Fourier basis for the graph Laplacian. For example, the signal processing unit 154 performs graph Fourier transform, graph filtering, or graph wavelet transform using the eigenvectors.

Here, graph Fourier transform of an undirected graph is defined by taking eigenvectors v of the graph Laplacian Lₚᵣᵢₒᵣ to be the Fourier basis. When a matrix in which the eigenvectors v are arranged in a column is denoted by V, graph Fourier transform for a graph signal f is defined as \hat{ }f=V*f (where “\hat{ }f” represents a symbol in which \hat{ } is added directly above f, and * represents complex conjugate transpose or adjoint). Most of elemental technologies of graph signal processing for undirected graphs are based on this graph Fourier transform.

The signal processing unit 154 extends the conventional graph Fourier transform for undirected graphs to apply the graph Fourier transform to a directed graph. The signal processing unit 154 executes two procedures of spectral decomposition of the Hermitian Laplacian L and extension of the graph Fourier transform to a directed graph.

First, since L is a Hermitian matrix, the signal processing unit 154 performs spectral decomposition of L using a matrix A in which eigenvalues A of L are arranged as diagonal elements and a unitary matrix U in which eigenvectors u are arranged in a column as shown in Expression (2). Note that the eigenvectors u are calculated by the calculation unit 153.

[Math. 2]

[symbol]

=UΛU* (2)

Also, the signal processing unit 154 can perform graph Fourier transform on a directed graph with respect to a graph signal f as shown in Expression (3), taking the eigenvectors u to be the Fourier basis.

[Math. 3]

\hat{f}=U*f (3)

Although a method for extending the graph Fourier transform is described here, the signal processing unit 154 can also extend elemental technologies of graph signal processing such as graph filtering and graph wavelet transform to a directed graph in a similar manner.

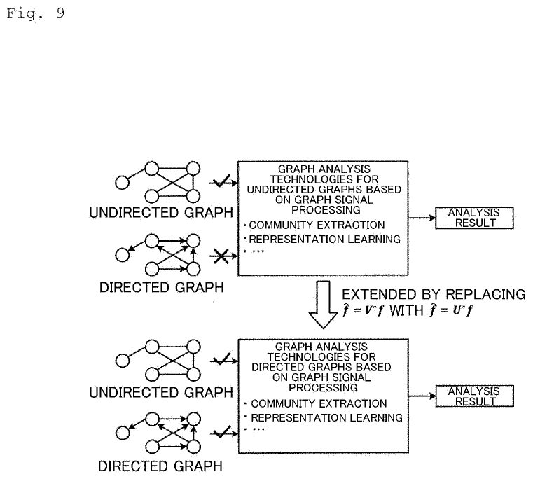

FIG. 9 is a diagram showing extension of graph analysis technologies. As shown in FIG. 9, it can be said that the signal processing unit 154 replaces the existing graph Fourier transform \hat{ }f=V*f for undirected graphs with the graph Fourier transform \hat{ }f=U*f for directed graphs. Thus, the signal processing unit 154 can easily extend existing graph analysis technologies for undirected graphs to directed graphs.

The analysis unit 155 analyzes the graph data based on the result of processing such as the Fourier transform executed by the signal processing unit 154. For example, as a result of the processing executed by the signal processing unit 154, the analysis unit 155 can apply a community extraction method, a representation learning method, and the like for graphs, which have been conventionally applicable only to undirected graphs, to a directed graph, and finally obtains an analysis result of the input graph.

### Processing of First Embodiment

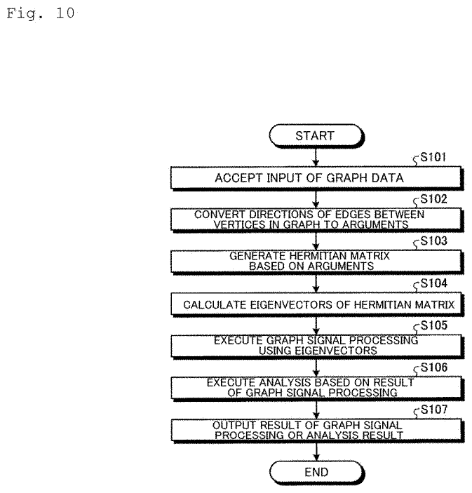

FIG. 10 is a flowchart showing a flow of processing that is performed by the graph analysis device according to the first embodiment. First, the graph analysis device 10 accepts input of graph data (step S101). The graph data is represented as an adjacency matrix, for example.

Next, the graph analysis device 10 converts directions of edges between vertices in the graph to arguments (step S102). For example, the graph analysis device 10 converts an edge having a direction to an angle θ and converts an edge having the opposite direction to an angle −θ.

The graph analysis device 10 generates a Hermitian matrix based on the arguments (step S103). For example, the graph analysis device 10 generates the Hermitian matrix by subtracting the converted adjacency matrix from a degree matrix. Also, the graph analysis device 10 calculates eigenvectors of the Hermitian matrix (step S104).

The graph analysis device 10 executes graph signal processing using the eigenvectors (step S105). Also, the graph analysis device 10 executes analysis based on the result of graph signal processing (step S106). Then, the graph analysis device 10 outputs the result of graph signal processing or the result of analysis (step S107). A configuration is also possible in which the graph analysis device 10 only outputs the result of graph signal processing. In this case, analysis based on the result of graph signal processing may be performed by another device or a person.

### Effects of First Embodiment

The conversion unit 151 converts directions of edges between vertices in a graph to arguments on a complex plane. The generation unit 152 generates a Hermitian matrix that represents a relationship between vertices in the graph by using the arguments converted by the conversion unit 151. The calculation unit 153 calculates eigenvectors of the Hermitian matrix generated by the generation unit 152. Thus, the graph analysis device 10 can obtain eigenvectors from a directed graph. The eigenvectors obtained here can be used in various types of graph signal processing. Therefore, according to the first embodiment, graph signal processing can be applied to a directed graph.

If the direction of an edge between vertices in the graph is a first direction, the conversion unit 151 converts the direction of the edge to a first angle, if the direction of the edge is opposite to the first direction, the conversion unit 151 converts the direction of the edge to an angle that is obtained by changing the sign of the first angle, and if the edge has no direction, the conversion unit 151 converts the direction of the edge to 0. The generation unit 152 generates a matrix that is obtained by subtracting, from a degree matrix of the graph, a matrix of which rows and columns correspond to vertices in the graph and in which, if there is an edge between vertices that correspond to an element, the element is a complex number that has an argument converted by the conversion unit 151 and a constant absolute value. Thus, the graph analysis device 10 can obtain a Hermitian matrix from a directed graph. In the first embodiment, graph signal processing can be applied to the directed graph by treating the Hermitian matrix similarly to a Laplacian.

The signal processing unit 154 performs graph signal processing taking the eigenvectors calculated by the calculation unit 153 to be a Fourier basis for the graph Laplacian. Also, the signal processing unit 154 performs graph Fourier transform, graph filtering, or graph wavelet transform using the eigenvectors. As described above, the graph analysis device 10 can obtain the Fourier basis, and therefore can execute various types of graph signal processing using the Fourier basis.

### Example

The following describes an example of a case where the graph analysis device 10 according to the first embodiment is applied to representation learning, which is one of graph analysis methods (Reference Literature: Donnat, C., Zitnik, M., Hallac, D., Leskovec, J.: Spectral graph wavelets for structural role similarity in networks. arXiv preprint arXiv:1710.10321(2017)).

Here, representation learning of a graph is a method of expressing vertices in the graph in the form of vectors, i.e., as feature vectors. Every existing machine learning technology takes feature vectors as inputs, and therefore, if feature vectors of vertices in a graph can be obtained through representation learning, it is possible to perform graph analysis such as community extraction, node malignancy prediction, and abnormality detection, by combining the representation learning with a suitable machine learning technology.

Note that an N-dimensional vector can be considered as being a point in an N-dimensional space. Accordingly, if representations are obtained such that vertices in the graph that are similar in some way are embedded spatially close to each other and vertices that differ from each other are embedded spatially away from each other, it is possible to determine that the representation learning is successful.

The following is an outline of the flow in this example.

Step S1: Input graph data and determine a Hermitian Laplacian that represents the structure of the graph.
Step S2: Calculate graph wavelets of respective vertices based on eigenvectors (i.e., the Fourier basis) of the Hermitian Laplacian.
Step S3: Design an embedding function from each graph wavelet and obtain an embedded representation of each vertex. That is, obtain feature vectors that represent structural features of the vertices.

Note that step S1 is performed by the conversion unit 151 and the generation unit 152, for example. Also, steps S2 and S3 are performed by the calculation unit 153 and the signal processing unit 154, for example. Also, the analysis unit 155 can perform machine learning or the like using the feature vectors obtained in step S3.

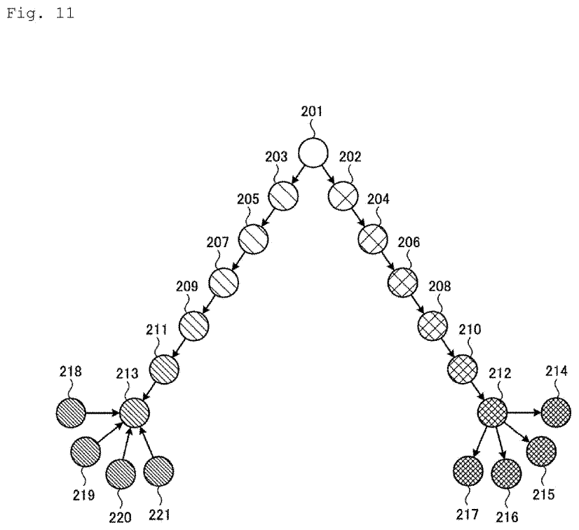

An example of graph data that is input to the graph analysis device 10 in step S1 is shown in FIG. 11. FIG. 11 is a diagram showing a graph according to the example. A left portion and a right portion of the directed graph shown in FIG. 11 have similar structures on the upstream side (in the vicinity of the vertex 201) but have different structures on the downstream side. More specifically, directions of edges that go out from the vertex 212 are opposite to directions of edges that enter the vertex 213.

Expression (4) shows a specific calculation for calculating a graph wavelet of each vertex i in step S2.

[Math. 4]

ψ_{s,i}:=UĜₛU*δᵢ

where

Filter kernel Ĝₛ=diag(ĝ(sλ₀), . . . ,\hat{g}(sλ_{N-1}))

Unit vector δᵢ:=({δᵢⱼ}ⱼ₌₁^{N}) (4)

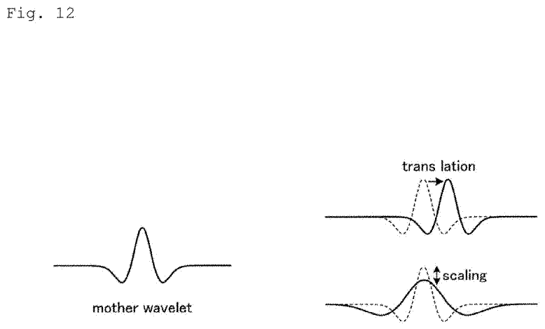

As shown in Expression (4), a graph wavelet is defined using eigenvalues and eigenvectors of the Hermitian Laplacian. \vec{ } Gₛ represents a diagonal matrix called a filter kernel. As shown in FIG. 12, a wavelet is generated by translating and/or scaling a wavelet that is called a mother wavelet and serves as a basis, and the wavelet is defined using parameters s and i that represent a scale and a position (vertex). FIG. 12 is a diagram showing the method for calculating a graph wavelet.

Steps for designing the embedding function in step S3 are shown in Expressions (5) and (6). First, the graph analysis device 10 prepares wavelets for various combinations of (s,i) to calculate the embedding function. At this time, the graph analysis device 10 takes the wavelets to be probability distributions. A function that is called a characteristic function and describes behavior of a probability distribution can be calculated for the probability function. Therefore, the graph analysis device 10 calculates the characteristic function for each wavelet as shown in Expression (5).

$$\begin{matrix}[ Math . 5 ] & \\ {ϕ}_{i} ( s , t ) = \frac{1}{N} {{\sum }^{N}}_{j = 1} {e}^{it {ψ}_{s , i} ( j )} & ( 5 )\end{matrix}$$

$$\begin{matrix}[ Math . 6 ] & \\ {X}_{i} = {[ Re ( {ϕ}_{i} ( s , t ) ) , Img ( {ϕ}_{i} ( s , t ) ) ]}_{t ∈ \{ {t}_{1} , … , {t}_{d} \} , s ∈ \{ {s}_{1} , … , {s}_{m} \}} & ( 6 )\end{matrix}$$

Based on the characteristic function obtained using Expression (5), the graph analysis device 10 can calculate an embedding function for the vertex i as shown in Expression (6). As shown in Expression (6), an embedded representation of each vertex is given in the form of a vector. Therefore, the embedded representation can be used as input in machine learning technologies such as support vector machines, neural networks, and the like.

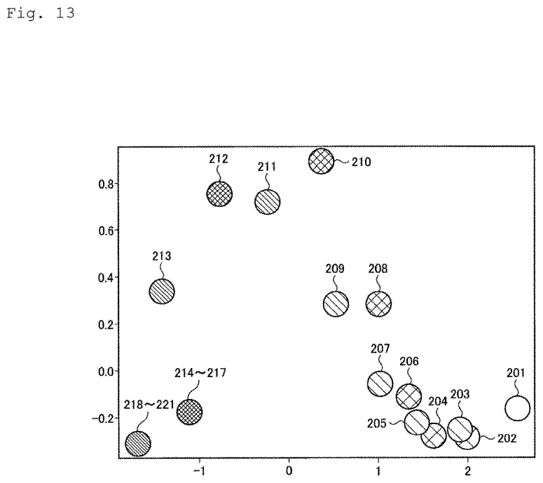

FIG. 13 shows a result that is obtained with respect to the directed graph shown in FIG. 11 by projecting vectors of embedded representations calculated in the above-described steps to a two-dimensional space through principal component analysis. FIG. 13 is a diagram showing embedded representations of vertices in the graph.

It can be found from FIG. 13 that pairs of vertices (a pair of vertices 202 and 203, a pair of vertices 204 and 205, and a pair of vertices 206 and 207) on the upstream side where the directed graph has similar structures are embedded close to each other. On the other hand, it can be found that the distance between corresponding vertices becomes larger toward the downstream side where the graph has different structures.

Also, the vertex 213 and the vertices 214 to 217 are sink nodes (vertices from which no edge goes out), but there is a difference in that the vertex 213 receives edges from many vertices, but the vertices 214 to 217 each receive an edge from a single vertex. Reflecting this difference, in FIG. 13, the vertex 213 is embedded far from the vertices 214 to 217. Based on the above, it can be said that good embedding can be realized through the representation learning based on the present invention.

System Configuration

The constitutional elements of the illustrated device represent functional concepts, and the device does not necessarily have to be physically configured as illustrated. That is, specific manners of distribution and integration of the functions of the device are not limited to those illustrated, and all or some portions of the device may be functionally or physically distributed or integrated in suitable units according to various types of loads or conditions in which the device is used. Also, all or some portions of each processing function executed in the device may be realized using a CPU and a program that is analyzed and executed by the CPU, or realized as hardware using a wired logic.

Also, out of the pieces of processing described in the present embodiment, all or some steps of a piece of processing that is described as being automatically executed may also be manually executed. Alternatively, all or some steps of a piece of processing that is described as being manually executed may also be automatically executed using a known method. The processing procedures, control procedures, specific names, and information including various types of data and parameters that are described above and shown in the drawings may be changed as appropriate unless otherwise stated.

Program

In one embodiment, the graph analysis device 10 can be implemented by installing a graph analysis program for executing the above-described graph analysis processing as packaged software or online software on a desired computer. For example, it is possible to cause an information processing device to function as the graph analysis device 10 by causing the information processing device to execute the graph analysis program. The information processing device referred to here encompasses a desktop or notebook personal computer. The information processing device also encompasses mobile communication terminals such as a smartphone, a mobile phone, and a PHS (Personal Handyphone System), and slate terminals such as a PDA (Personal Digital Assistant).

Also, the graph analysis device 10 can be implemented as a graph analysis server device that provides a service related to the above-described graph analysis processing to a client that is a terminal device used by a user. For example, the graph analysis server device is implemented as a server device that provides a graph analysis service by taking graph data as input and outputting a result of graph signal processing or an analysis result of the graph data. In this case, the graph analysis server device may be implemented as a Web server or a cloud that provides a service related to the above-described graph analysis processing through outsourcing.

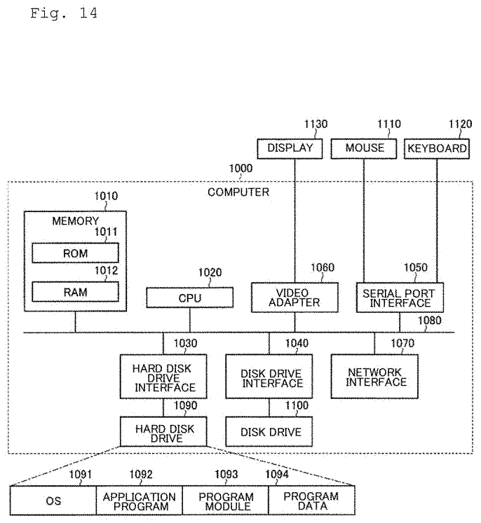

FIG. 14 is a diagram showing an example of a computer that executes the graph analysis program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected via a bus 1080.

The memory 1010 includes a ROM (Read Only Memory) 1011 and a RAM 1012. A boot program such as BIOS (BASIC Input Output System) is stored in the ROM 1011, for example. The hard disk drive interface 1030 is connected to a hard disk drive 1090. The disk drive interface 1040 is connected to a disk drive 1100. An attachable and detachable storage medium such as a magnetic disk or an optical disk is inserted into the disk drive 1100, for example. The serial port interface 1050 is connected to a mouse 1110 and a keyboard 1120, for example. The video adapter 1060 is connected to a display 1130, for example.

An OS 1091, an application program 1092, a program module 1093, and program data 1094 are stored in the hard disk drive 1090, for example. That is, a program that defines processing performed by the graph analysis device 10 is implemented as the program module 1093 in which codes that can be executed by the computer are written. The program module 1093 is stored in the hard disk drive 1090, for example. For example, the program module 1093 for executing processing similar to the functional configuration of the graph analysis device 10 is stored in the hard disk drive 1090. Note that the hard disk drive 1090 may be replaced with an SSD.

Setting data that is used in the processing performed in the above-described embodiment is stored as the program data 1094 in the memory 1010 or the hard disk drive 1090, for example. The CPU 1020 reads out the program module 1093 and the program data 1094 stored in the memory 1010 or the hard disk drive 1090 into the RAM 1012 as necessary and executes the processing in the above-described embodiment.

Note that the program module 1093 and the program data 1094 do not necessarily have to be stored in the hard disk drive 1090, and may also be stored in an attachable and detachable storage medium and read out by the CPU 1020 via the disk drive 1100 or the like, for example. Alternatively, the program module 1093 and the program data 1094 may also be stored in another computer that is connected via a network (LAN (Local Area Network), WAN (Wide Area Network), etc.). The program module 1093 and the program data 1094 may also be read out from the other computer by the CPU 1020 via the network interface 1070.

### REFERENCE SIGNS LIST

10 Graph analysis device
11 Communication unit
12 Input unit
13 Output unit
14 Storage unit
15 Control unit
20 Graph data
20A, 20D, 20L Matrix
30 Analysis result
151 Conversion unit
152 Generation unit
153 Calculation unit
154 Signal processing unit
155 Analysis unit

1. A graph analysis device comprising: a memory; and a processor coupled to the memory and programmed to execute a process comprising: converting directions of edges between vertices in a graph to arguments on a complex plane;
generating a Hermitian matrix that represents a relationship between vertices in the graph by using the arguments converted by the converting; and
calculating eigenvectors of the Hermitian matrix generated by the generating.

2. The graph analysis device according to claim 1, wherein
if the direction of an edge between vertices in the graph is a first direction, the converts the direction of the edge to a first angle, if the direction of the edge is opposite to the first direction, the converts the direction of the edge to an angle that is obtained by changing the sign of the first angle, and if the edge has no direction, the converting converts the direction of the edge to 0, and
the generating generates a matrix that is obtained by subtracting, from a degree matrix of the graph, a matrix of which rows and columns correspond to vertices in the graph and in which, if there is an edge between vertices that correspond to an element, the element is a complex number that has an argument converted by the converting and a constant absolute value.

3. The graph analysis device according to claim 1, further comprising
performing graph signal processing taking the eigenvectors calculated by the calculating to be a Fourier basis for a graph Laplacian.

4. The graph analysis device according to claim 3, wherein
the performing performs graph Fourier transform, graph filtering, or graph wavelet transform using the eigenvectors.

5. A graph analysis method to be executed by a computer, the method comprising:
converting directions of edges between vertices in a graph to arguments on a complex plane;
generating a Hermitian matrix that represents a relationship between vertices in the graph by using the arguments converted in the converting, and
calculating eigenvectors of the Hermitian matrix generated in the generating.

6. (canceled)

7. A non-transitory computer-readable recording medium storing therein a graph analysis program that causes a computer to execute a process comprising:
converting directions of edges between vertices in a graph to arguments on a complex plane;
generating a Hermitian matrix that represents a relationship between vertices in the graph by using the arguments converted by the converting; and
calculating eigenvectors of the Hermitian matrix generated by the generating.
